(19) United States
(12) Patent Application Publication
(10) Pub. No.: US 2016/0189250 A1
(43) Pub. Date: Jun. 30, 2016

(54) ELECTRONIC REVENUE SHARING SYSTEM

(71) Applicant: Target Brands Inc., Minneapolis, MN (US)

(72) Inventors: Patrick Vesperman, New Brighton, MN (US); Peter Stromquist, Little Canada, MN (US)

(21) Appl. No.: 14/587,108

(22) Filed: Dec. 31, 2014

(51) Int. Cl. G06Q 30/02; G06Q 50/00; G06Q 20/10

(52) U.S. Cl. CPC G06Q 30/0279; G06Q 20/10; G06Q 50/01

(57) ABSTRACT

An electronic revenue sharing system and method of administering are disclosed. The system includes a user interface configured to enable a shopper to purchase one or more products loadable onto a user device including a display and an input and a server communicable with the user device. The server is configured to receive a donation request from the user device. The system includes a database accessible to the server, the database including profile information for an institution; donation categories; donation goals corresponding to the donation categories; and donation amounts. The server is configured to receive the donation request from the user device, retrieve data stored in the database, cause display of the user interface according to the data retrieved, receive a purchase request from the user interface, calculate a corresponding donation amount based on the purchase request, and initiate a distribution of the corresponding donation amount to the institution.

### FIELD

This disclosure generally relates to an electronic revenue sharing system. More specifically, this disclosure relates to systems and methods for an institution to receive profits shared by a retail organization when a shopper makes purchases.

### BACKGROUND

Online shopping is a continuously growing industry. A user engaging in online shopping can locate potential products of interest in a number of ways, including by conducting Internet searching or going directly to a website known by the user. Institutions such as, but not limited to, non-profit organizations (e.g., schools, community organizations, charities, or the like), often rely on donations (e.g., monetary gifts) to purchase equipment, fund activities, or the like. Institutions often have an online presence (e.g., website, social networking, or the like). The institutions are often capable of receiving monetary gifts through their website. Improved ways for institutions to receive monetary gifts are desirable.

### SUMMARY

This disclosure generally relates to an electronic revenue sharing system. More specifically, this disclosure relates to systems and methods for an institution to receive profits shared by a retail organization when a shopper makes purchases.

In one embodiment, an electronic revenue sharing system includes a server communicable with a network. The server executes instructions for a user interface loadable to a user device. The user interface is configured to enable a shopper to purchase one or more products. A database is electronically accessible to the server. The database includes profile information for an institution, donation categories and donation goals, and donation amounts. The server is configured to receive a purchase request and/or a donation request initiated by the shopper. The server is configured to retrieve data stored in the database in responding to the request; the data including profile information for the institution, donation categories and donation goals, and/or donation amounts. The server is configured to cause display of the user interface according to the data retrieved. The server is configured to calculate a corresponding donation amount based on the purchase request. The server is configured to distribute the corresponding donation amount to the institution.

In another embodiment, an electronic revenue sharing system includes a retailer server communicable with a network. The server executes instructions of a user interface loadable to a user device. The user interface configured to enable a shopper to purchase one or more products. The revenue sharing system further comprises a database electronically accessible to the server; the database includes profile information for an institution; donation categories and donation goals; and donation amounts. An orientation kit is provided by the retail server to an institution server communicable to the network. The orientation kit is configured to enable the shopper to make a purchase request and/or a donation request through the institution server. A computer readable data instruction is executed by the retail server to retrieve data from the database. A computer readable update instruction is executed by the retail server to update the user interface according to the data retrieved. A computer readable calculation instruction is executed by the retail server to calculate a donation amount according to the purchase request and/or the donation request. A computer readable distribution instruction is executed by the retail server to distribute the donation amount to the institution.

A method for administering an electronic revenue sharing system is described. The method includes displaying an electronic revenue sharing system user interface of an institution on a user device; receiving a donation request from the user device, the donation request indicating selection of a particular donation category for the institution; receiving a purchase request from the user device, the purchase request indicating one or more items a shopper has selected for purchase; and calculating a donation amount based on the purchase request.

### BRIEF DESCRIPTION OF THE DRAWINGS

References are made to the accompanying drawings that form a part of this disclosure and which illustrate the embodiments in which the systems and methods described in this Specification can be practiced.

FIG. 1 is a schematic diagram of a system for implementing an electronic revenue sharing system as described herein, according to an embodiment.

FIG. 2 illustrates an institution user interface for the electronic revenue sharing system as described herein, according to an embodiment.

FIG. 3 illustrates a social network user interface for the electronic revenue sharing system as described herein, according to an embodiment.

FIG. 4 illustrates an electronic revenue sharing system landing user interface, according to an embodiment.

FIG. 5 illustrates an electronic revenue sharing system user interface of an institution, according to an embodiment.

FIG. 6 illustrates a flowchart of a process for an institution to participate in the electronic revenue sharing system as described herein, according to an embodiment.

FIG. 7 illustrates a flowchart of a process for a shopper to donate to an institution participating in the electronic revenue sharing system as described herein, according to an embodiment.

FIG. 8 illustrates a schematic diagram of an architecture for a computer device, according to an embodiment.

Like reference numbers represent like parts throughout.

### DETAILED DESCRIPTION

This disclosure generally relates to an electronic revenue sharing system. More specifically, this disclosure relates to systems and methods for an institution to receive profits shared by a retail organization when a shopper makes purchases.

An electronic revenue sharing system is described that enables a shopper to contribute a monetary gift to an institution through making purchases from a retail organization (e.g., through the retail organization's website or other user interface accessible via the Internet). The electronic revenue sharing system makes a user interface available to a shopper that enables the shopper to purchase one or more products. A portion (e.g., a percentage) of the purchase amount can then be donated to the institution. In an embodiment, the donation can go directly to a particular donation category (e.g., an area of particular need for the institution, etc.) as selected by the shopper when beginning shopping.

A shopper may initiate a shopping process and interaction with the electronic revenue sharing system in a variety of ways. For example, the shopper can enter the electronic revenue sharing system through a website or other user interface (e.g., an application for a mobile device, etc.) of an institution, a social network including a user interface associated with the institution, a user interface of the electronic revenue sharing system associated with the retail organization, or the like.

An institution can create one or more donation categories having different donation goals. It is to be appreciated that the one or more categories can also include donation goals that are the same, according to an embodiment. A shopper can begin shopping through a selection in a particular one of the donation categories in order to cause a donation resulting from the shopper's purchase amount to be directed to a fund associated with the particular donation category selected.

In an embodiment, a user interface of the retail organization can track an amount donated to the institution and display that amount as compared to the donation goal.

In an embodiment, a retail organization can provide an orientation kit to an institution that is part of the electronic revenue sharing system. The orientation kit can, for example, include computer programming code that the institution can insert into one or more user interfaces of the institution (e.g., the institution's website, social media user interface, or the like) in order to provide a connector which enables a shopper to be forwarded directly to the electronic revenue sharing system user interfaces of the retail organization.

In an embodiment, a shopper may have an account with the retail organization which designates a default donation institutions and/or donation categories. In such an embodiment, if the shopper logs in under her membership while shopping, the shopper can donate to the default institution without any selection before shopping. However, if the shopper initiated a purchase request through an institution user interface (e.g., website, social media user interface, or the like) that is different from the default institution, then the electronic revenue sharing system can determine to whom to provide the donation. The determination process may include, for example, popping a message box asking the shopper to re-select an institution to which to donate. If the shopper's intention is to donate to a new institution different from the default institution, the donation amount can be distributed to the new institution. If the shopper's intention is to donate to the default institution, the revenue sharing system will distribute the donation amount to the default institution.

An institution includes, but is not limited to, a non-profit organization. Examples of non-profit organizations include, but are not limited to, schools, community organizations, charities, or the like. It is to be appreciated that a for-profit institution could be included according to principles described in this Specification.

A shopper includes, for example, a user of a user interface (e.g., a retail organization's website or the like) for considering purchase of one or more items sold through the user interface. A shopper can also be referred to as, for example, a user, a purchaser, a consumer, a customer, a guest, or the like.

A social network includes, for example, a social media website. Social networks include, but are not limited to, Pinterest, Facebook, Twitter, Google+, or the like.

A donation category includes, for example, an intended use for donations. A donation category may be specific to an institution, according to an embodiment. Examples of donation categories include, but are not limited to, donations for classroom supplies, donations for class/school computers/tablet devices, donations for playground equipment, donations for library collections, donations for a general fund, or the like. It is to be appreciated that these donation categories are intended to serve as examples and that one or more additional donation categories can be crated in accordance with the principles described in this Specification.

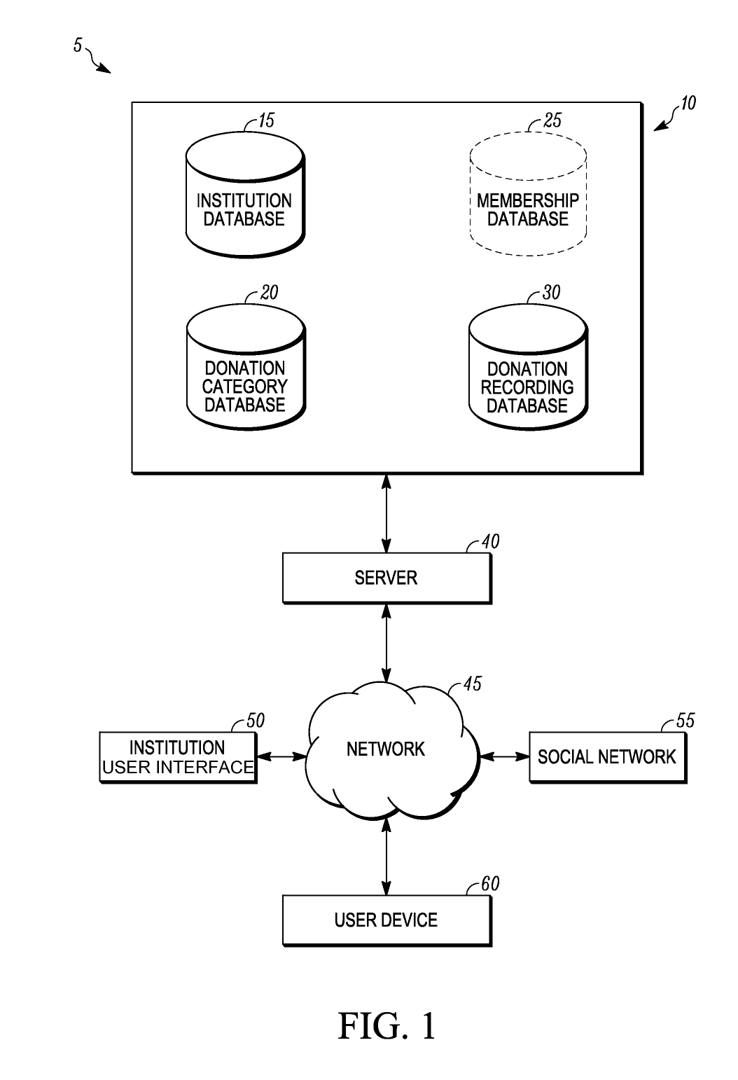

FIG. 1 is a schematic diagram of a system 5 for implementing an electronic revenue sharing system as described herein, according to an embodiment. In the system 5, a server 40 is connected in communication with a user device 60 via a network 45.

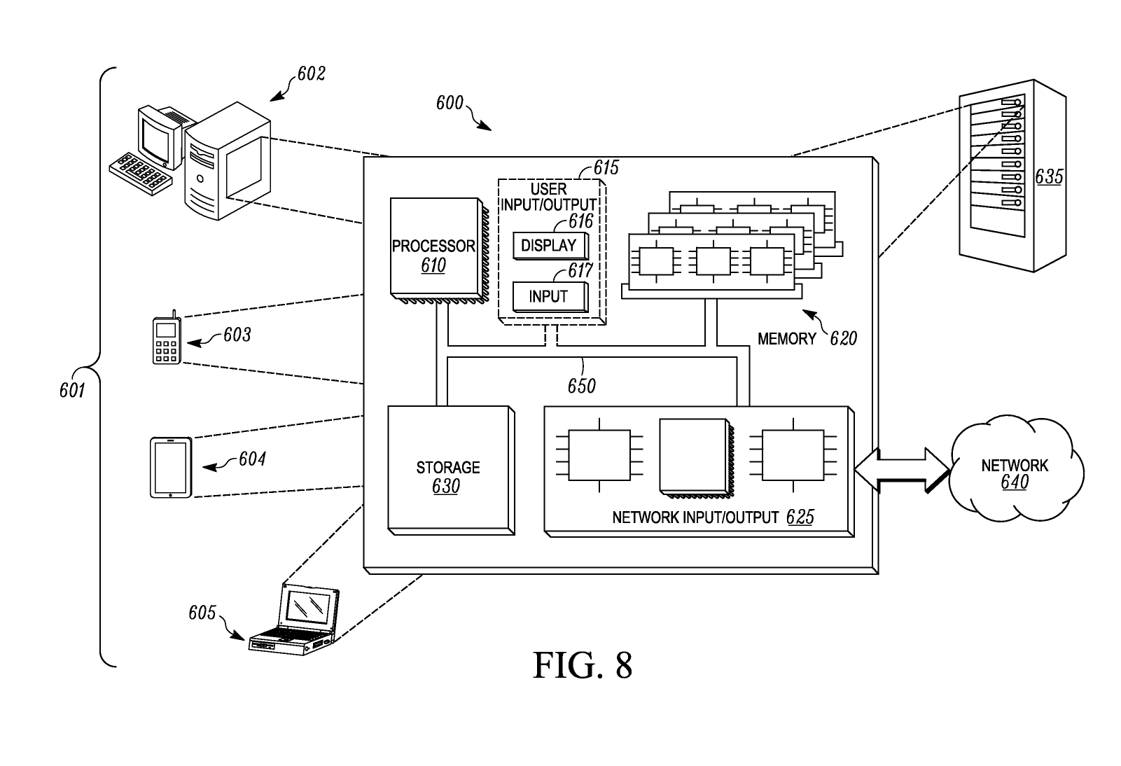

The server 40 makes a user interface available to the user device 60. The user interface may include webpages, text, figures, sound tracks, or the like, along with suitable combinations thereof. The server 40 makes the user interface available over the network 45 according to principles known in the art suitable for allowing a user to access and view the user interface with the user device 60. In an embodiment, aspects of the server 40 are the same as or similar to aspects of server device 635 as described in accordance with FIG. 8 below.

The network 45 can include, for example, a local area network (LAN), a wide area network (WAN), a wireless network, a cellular data network, or the like, along with suitable combinations thereof. In an embodiment, aspects of the network 45 are the same as or similar to aspects of network 640 as described in accordance with FIG. 8 below.

A shopper can purchase one or more products, thereby donating to an institution, by accessing the user interface via the network 45 and the user device 60. The shopper can access the user interface using any conventional manner including, but not limited to, using a personal computer (PC), a laptop computer, a mobile device (e.g., a smartphone, a personal digital assistant (PDA), or the like), a tablet-style device, or the like. The user interface is displayed on a display of the user device 60. Examples of the display for the user device include, but are not limited to, a monitor connected to a PC, a laptop screen, a mobile device screen, a tablet screen, or the like. In an embodiment, aspects of the user device 60 are the same as or similar to aspects of user devices 601 as described in accordance with FIG. 8 below.

The server 40 is in communication with a database 10. The database 10 can include a variety of information, such as, but not limited to, profile information for one or more institutions; donation categories and goals for the one or more institutions; membership information; donation amounts; or the like, along with suitable combinations thereof. Profile information of an institution is stored in institution database 15. Donation categories and donation goals are stored in donation category database 20. Membership information is stored in membership database 25. Membership information is optional to the electronic revenue sharing system. It is to be appreciated that the information can be stored in multiple databases, within the same database, or the like.

The server 40 can be configured to receive a purchase request and/or a donation request initiated by a shopper. The server 40 can be configured to retrieve data stored in the database 10 in response to the requests. The retrieved data can include, for example, the profile information for the institution, donation categories and goals, membership information, and donation amounts. The server can calculate a donation amount according to the purchase request. The server, then, can initiate a distribution of the donation amount to the institution.

A shopper may begin shopping in a variety of ways. In one embodiment, the shopper may begin shopping through an institution user interface 50. The institution user interface 50 is in communication with the network 45. The institution user interface 50 includes a connector, such as, but not limited to, a hyperlink, which directs the shopper to a retailer's user interface. In another embodiment, the shopper may begin shopping through a social network 55. The social network 55 is in communication with the network 45. The social network 55 includes a social network user interface which can forward a shopper to the institution. The social network user interface can include, a connector, such as, but not limited to, a hyperlink, such that the shopper may be directed to the retailer's user interface to shop. In yet another embodiment, the shopper may begin shopping via retailer's user interface.

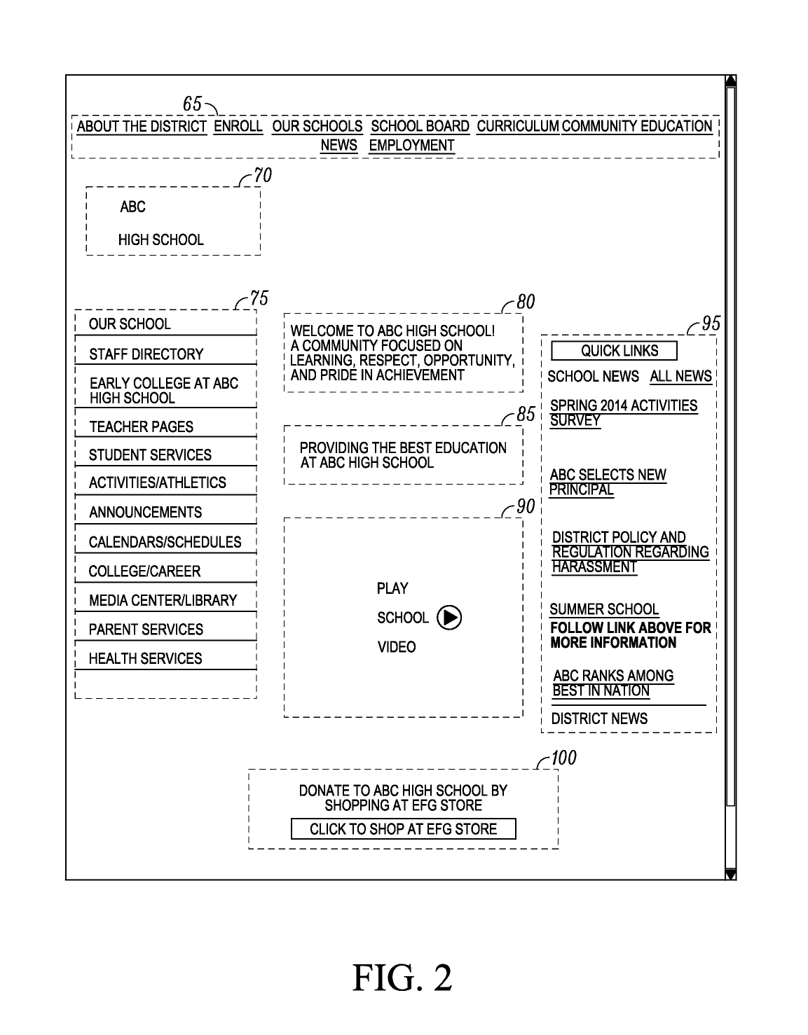

FIG. 2 illustrates an institution user interface for the electronic revenue sharing system as described herein, according to an embodiment. It is to be appreciated that all text and arrangement of the text are examples and can vary according to the principles described herein.

In the illustrated embodiment, an institution is ABC High School (hereinafter “ABC High”). The institution user interface generally includes a navigation bar 65, an institution logo 70, a navigation side bar 75, a welcome message 80, a slogan block 85, an institution video 90, and a link bar 95. It should be noted that all aspects mentioned above are not required for the institution user interface. Further, the institution user interface can include one or more additional aspects.

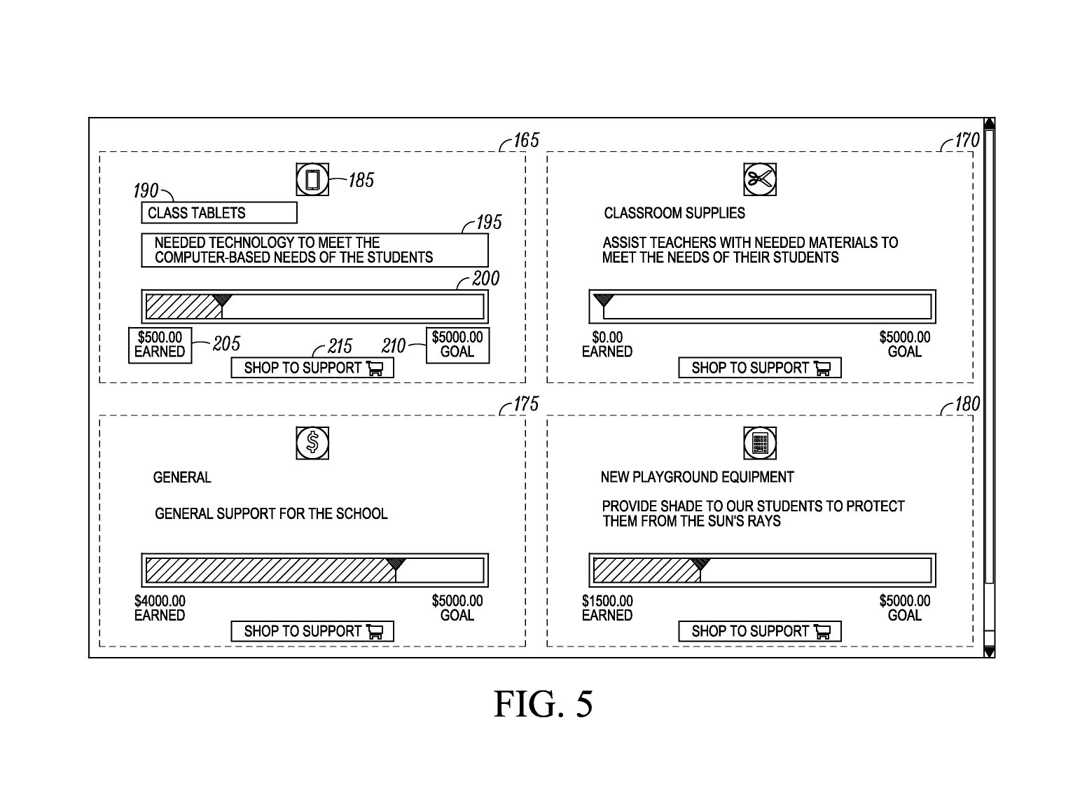

The institution user interface can include a connector 100. The connector 100 is configured to forward the shopper to a retailer's user interface (e.g., EFG store's user interface) when selected. While the shopper is browsing the institution user interface, the shopper may wish to donate to ABC High. The connector 100 can be selected in order to direct the shopper to a retailer's user interface (e.g., a revenue sharing system user interface of an institution as described in accordance with FIG. 5 below) for EFG store to begin shopping and make donations.

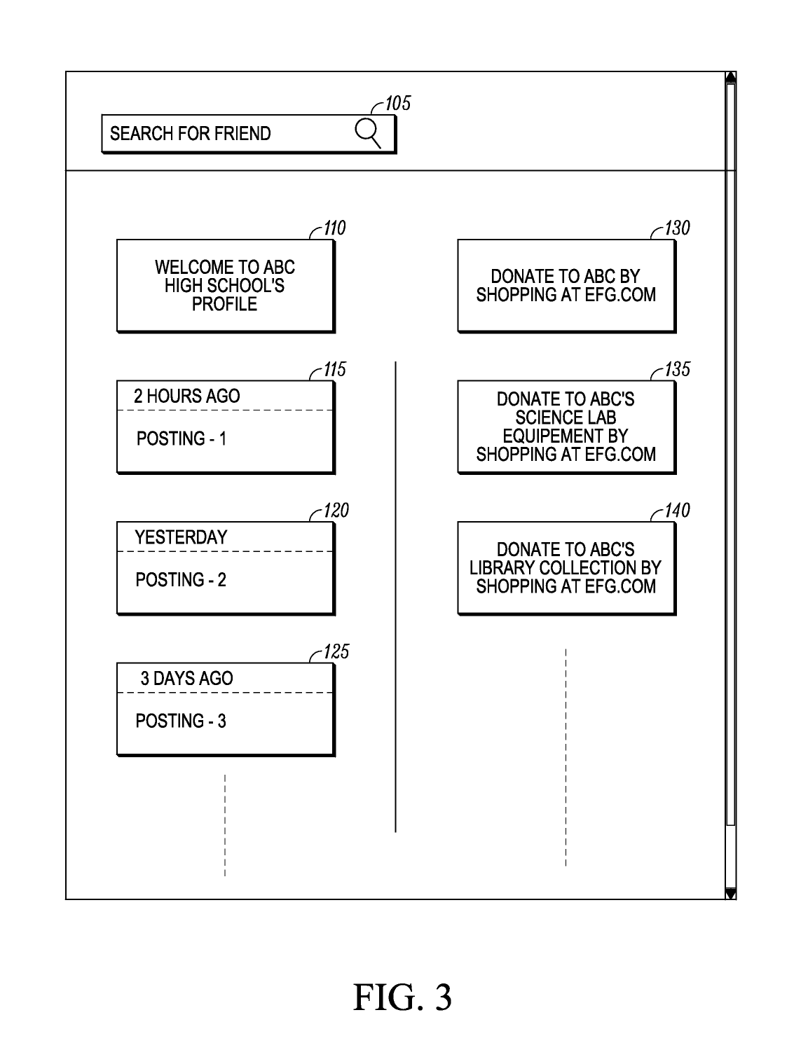

FIG. 3 illustrates a social network user interface for the electronic revenue sharing system as described herein, according to an embodiment. It is to be appreciated that all text and arrangement of the text are examples and can vary according to the principles described herein. In one embodiment, a shopper may enter the electronic revenue sharing system through the social network user interface.

In one embodiment, an institution may have a social network user interface available through the social network. For example, ABC High may have a social network user interface available through one or more social networks, as shown in FIG. 3. The social network user interface can include a search bar 105 and a welcome message 110. The social network user interface can also include a plurality of postings 115, 120, 125 about ABC High. The postings 115, 120, 125 can be organized, for example, by time posted.

The social network user interface can include a plurality of connectors 130, 135, 140. When selected, the connectors 130, 135, 140 direct a shopper to a retailer's user interface. The connectors 130, 135, 140 can direct the shopper to different user interfaces associated with different donation categories. For example, the connector 130 can direct the shopper to an electronic revenue sharing system user interface of an institution as shown and described in accordance with FIG. 5 below. In another embodiment, the connectors 135, 140 can direct the shopper to a user interface showing a specific donation category of ABC High. In one embodiment, the connector 135 can direct the shopper to a donation user interface for science lab equipment for ABC High. In another example, the connector 140 can direct the shopper to a donation user interface for a library collection of ABC High. It is to be appreciated that the donation categories are examples and are not intended to be limiting.

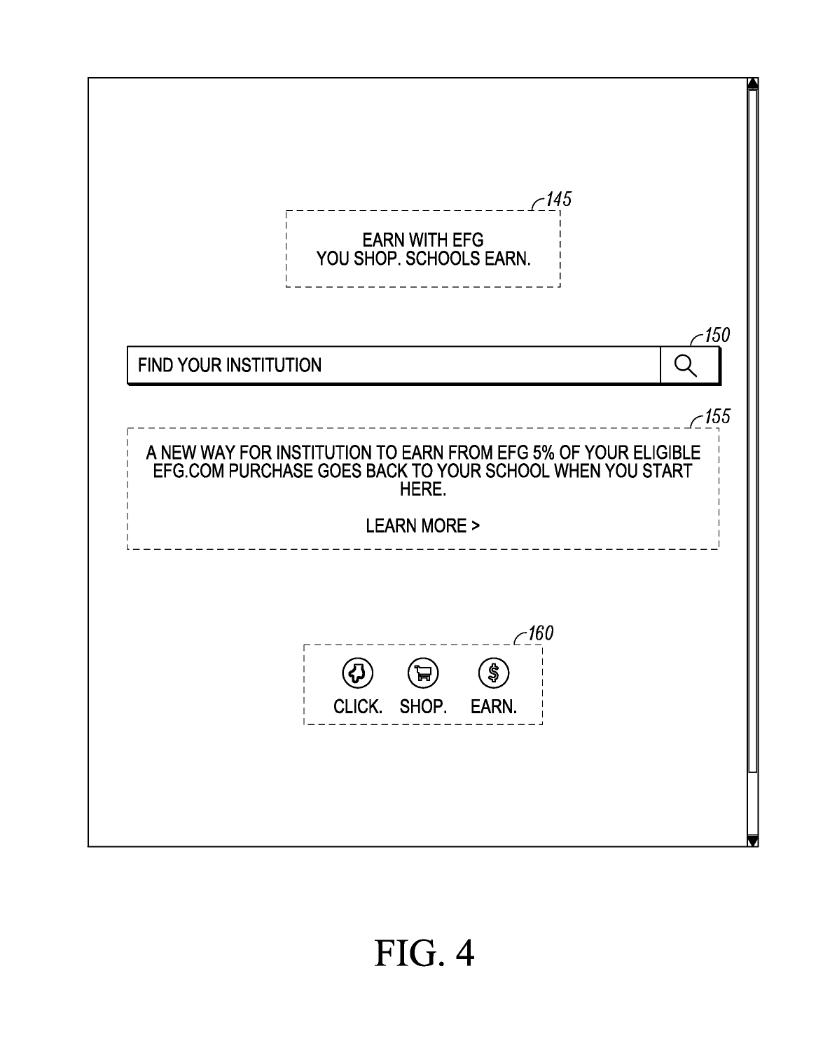

FIG. 4 illustrates an electronic revenue sharing system landing user interface. In one embodiment, a shopper may initiate a donation request via the electronic revenue sharing system landing user interface. It is to be appreciated that all text and arrangement of the text are examples and can vary according to the principles described herein.

The electronic revenue sharing system landing user interface includes a search bar 150. A shopper can search for an institution that is enrolled in the electronic revenue sharing system using the search bar 150. The electronic revenue sharing system landing user interface may further include a welcome message 145, a message block 155, and/or an advertisement block 160.

It is to be appreciated that the shopper can enter or initiate a purchase request in the revenue sharing system in a variety of ways. This is not limited to an institution website as shown in FIG. 2, social network as shown in FIG. 3, and/or revenue sharing system landing interface as shown in FIG. 4.

FIG. 5 illustrates an electronic revenue sharing system user interface of an institution, according to an embodiment. It is to be appreciated that all text and arrangement of the text are examples and can vary according to the principles described herein.

The electronic revenue sharing system user interface of an institution can be based on information provided by the institution when the institution enrolled into the electronic revenue sharing system. The electronic revenue sharing system user interface of an institution includes different donation category panels 165, 170, 175, 180. Four donation categories are illustrated, but it is to be appreciated that fewer or additional donation categories can be included. Each donation category panel 165, 170, 175, 180 represents a single donation category. For example, donation category panel 165 represents a donation category of class tablets. Class tablets may be, e.g., handheld tablets that may have educational programs installed to enhance the learning experience of students. Donation category panel 170 represents a donation category of classroom supplies (e.g., copy paper, printer cartridges, pencils, or the like, along with suitable combinations thereof). Donation category panel 175 represents a donation category of a general fund. The general fund can be used by an institution for general operation purposes (e.g., funds may be directed to areas of greatest need, etc.). Donation category panel 180 represents a donation category for new playground equipment. It is to be appreciated that these donation categories are provided as examples, and that the donation category can be modified to meet an institution's particular needs according to the principles described herein.

Each of the donation category panels 165, 170, 175, 180 can include a category icon 185, a category title 190, a category description 195, a tracking bar 200, an accumulation number 205, a donation goal 210, and a connector 215. The category icon 185 is a graphical representation of the donation category. The category title 190 can be a single word or a short phrase representing the donation category. The category description 195 can be one or more short sentences providing further details of the donation category. The tracking bar 200 can be a graphical representation of the accumulated donation amount for the donation category. The tracking bar 200 may have two ends, one end representing the start of accumulation, i.e., $0; the other end representing the donation goal. The tracking bar 200 can, for example, be shaded depending on an accumulation number 205 to more easily identify progress toward the donation goal. The accumulation number 205 is a numerical representation of the current amount of donation received. The donation goal 210 is a numerical representation of the donation goal set by the institution. By clicking on the connector 215, the shopper is directed to a retail website or other user interface of a retail organization. In addition, by clicking on the connector 215 for a specific donation category panel 165, 170, 175, 180 the shopper makes her selection to donate to that specific donation category for the institution. For example, if the shopper clicks on the connector 215 that is on the donation panel 165, the shopper makes her selection to donate to the class tablet category for the institution. Upon completion of a shopper's purchase, the electronic revenue sharing system distributes the donation amount to the specific category for the specific donation category for the institution. In some embodiments, if a shopper has an account with the retail organization and a selection is in conflict with a shopper's selected institution corresponding to the account, the selection may override the shopper's default institution.

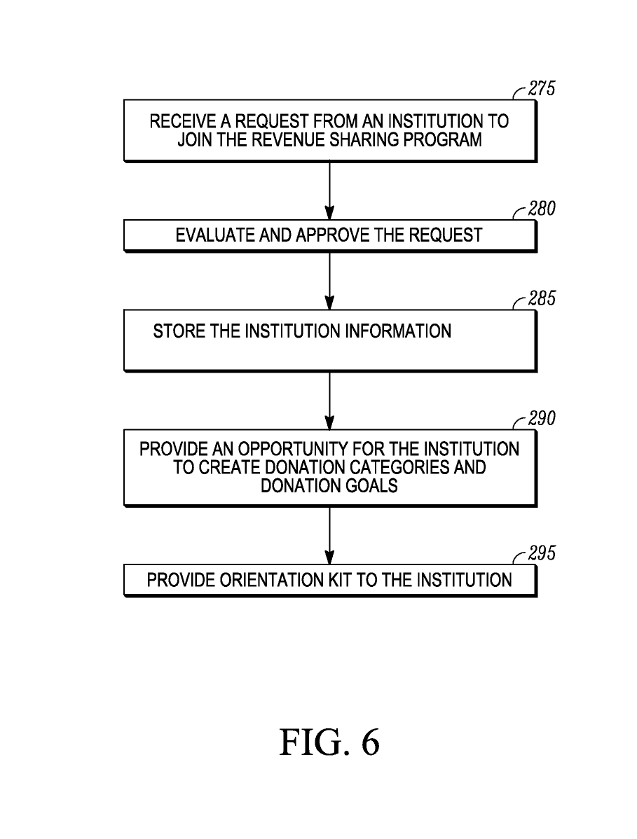

FIG. 6 illustrates a flowchart of a process for an institution to participate in the electronic revenue sharing system as described herein, according to an embodiment. A request from an institution to join the electronic revenue sharing system is received at 275. The retail organization running the program evaluates and approves the request at 280. A profile including, for example, the name, nature of business or services, slogan, or the like is stored (e.g., in a database, such as, but not limited to, institution database 15 shown in FIG. 1) at 285. The institution can create its own donation categories and donation goals at 290. In an embodiment, if the institution does not create its own donation categories, the retail organization can include a default donation category such as, but not limited to, a general fund. At 295, the electronic revenue sharing system provides an orientation kit to the enrolled institution 295. In one embodiment, the orientation kit includes a connector (e.g., connector 100 in FIG. 2) for the institution such that a shopper can navigate from an institution user interface (e.g., an institution user interface as illustrated in FIG. 2 or a social network user interface as illustrated in FIG. 3) to an electronic revenue sharing system user interface (e.g., the electronic revenue sharing system landing user interface as illustrated in FIG. 4 or the electronic revenue sharing system user interface of an institution as shown in FIG. 5). In one embodiment, the orientation kit includes multiple connectors for the institution (e.g., connector 130, 135, 140 in FIG. 3), such that the shopper can initiate a donation to the institution for a particular donation category. The orientation kit may include, e.g., program code (e.g. HTML, etc.), text, figures, numbers, symbols, or the like.

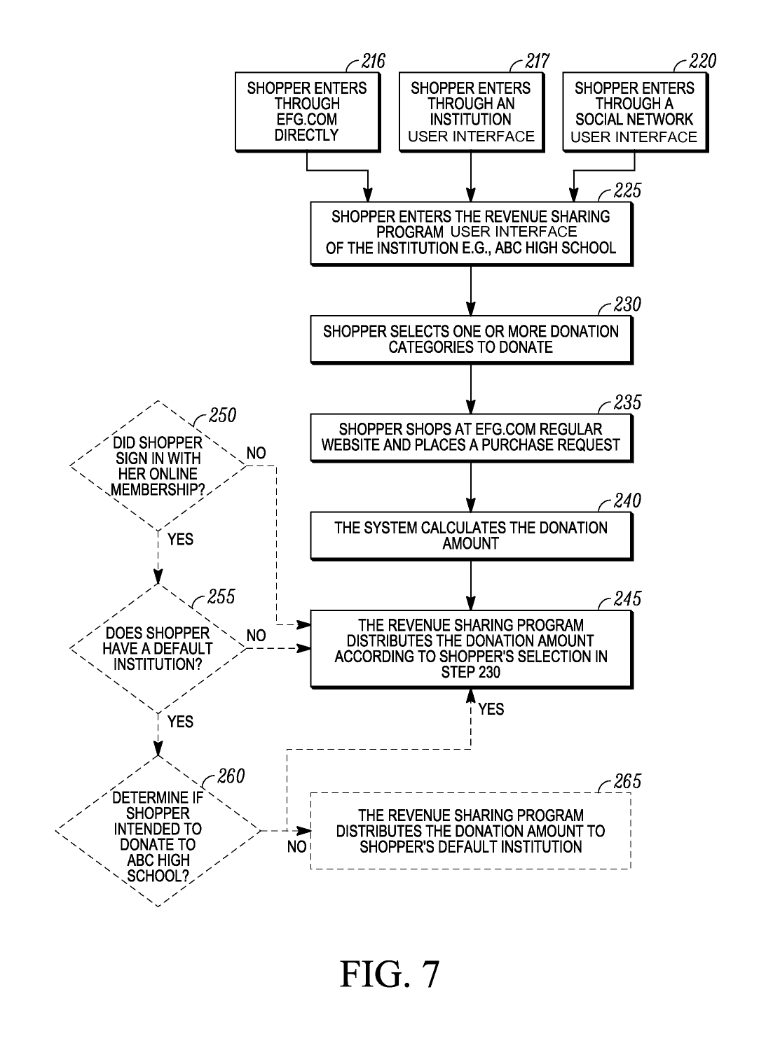

FIG. 7 illustrates a flowchart of a process for a shopper to donate to an institution participating in the electronic revenue sharing system, according to an embodiment.

A shopper may enter the electronic revenue sharing system user interface (e.g. as shown in FIG. 5) of ABC High 225 through at least three starting points 216, 217, 220. One starting point is through the retail organization's website EFG.com 216. In some embodiments, this includes a shopper entering through a revenue sharing system landing interface (e.g., as shown in FIG. 4). Another starting point is through an institution user interface 217 (e.g., an institution's website as shown in FIG. 2). Yet another starting point is through a social network user interface 220 (e.g., as shown in FIG. 3). It should be understood that the starting points the shopper can enter or initiate a purchase request in the electronic revenue sharing system are not limited to the three starting points mentioned in this paragraph. Other starting points may be available, such as, but not limited to, targeted advertisements, content specific advertisements, and the like. Note that when the shopper enters the revenue sharing system user interface at 225 through any one of the three starting points mentioned, the institution intended for donation is identified. Consequently, the shopper selects one or more donation categories to which to donate at 230. After selecting the donation category, the shopper continues to shop at the retail organization (e.g., EFG.com, an application for a mobile device, or the like) and completes a purchase 235. It is to be appreciated that the shopper shops according to principles known in the art. The electronic revenue sharing system then calculates the donation amount based on the purchase request 240. In one embodiment, the donation amount can be a percentage of the amount of the purchase request.

The revenue sharing system then distributes the donation amount according to shopper's selection 245. In one embodiment, the shopper may have an account on the retailer's user interface. In another embodiment, the shopper has designated a default institution for donation. In some cases, shopper's selection 230 may be in conflict with the default institution. As shown in FIG. 7, in such a situation, the electronic revenue sharing system can determine whether the shopper logged in to the EFG.com shopping website with her online membership 250. If the shopper does not have an online membership or was shopping anonymously, the revenue sharing system distributes the donation amount to the shopper's selection from 230. If the shopper logged in with her online membership, then the program determines whether the shopper has a default institution for donation at 255. The default institution may be an institution and/or donation categories identified in the shopper's profile by the shopper. The donation amount calculated according to shopper's purchase request will be distributed to the default institution if there is no other conflicting information. If the shopper does not have a default institution, the electronic revenue sharing system distributes the donation money to shopper's selection from 230. If the shopper does have a default institution that is in conflict with shopper's selection in 230, then the electronic revenue sharing system determines to whom the shopper intends to donate at 260. In one embodiment, this can include prompting the shopper to confirm whether to donate to the institution selected in 230. If the shopper indicates the institution from 230, then the donation amount will be provided to the institution selected in 230. If the shopper does not indicate the institution from 230, then the donation amount will be provided to the default institution at 265.

FIG. 8 is a schematic diagram of an architecture for a computer device 600. The computer device 600 and any of the individual components thereof can be used for any of the operations described in accordance with any of the computer-implemented methods described herein.

The computer device 600 generally includes a processor 610, memory 620, a network input/output (I/O) 625, storage 630, and an interconnect 650. The computer device 600 can optionally include a user I/O 615, according to some embodiments. The computer device 600 can be in communication with one or more additional computer devices 600 through a network 640.

The computer device 600 is generally representative of hardware aspects of a variety of user devices 601 and a server device 635. The illustrated user devices 601 are examples and are not intended to be limiting. Examples of the user devices 601 include, but are not limited to, a desktop computer 602, a cellular/mobile phone 603, a tablet device 604, and a laptop computer 605. It is to be appreciated that the user devices 601 can include other devices such as, but not limited to, a personal digital assistant (PDA), a video game console, a television, or the like. In some embodiments, the user devices 601 can alternatively be referred to as client devices 601. In such embodiments, the client devices 601 can be in communication with the server device 635 through the network 640. One or more of the client devices 601 can be in communication with another of the client devices 601 through the network 640 in some embodiments.

The processor 610 can retrieve and execute programming instructions stored in the memory 620 and/or the storage 630. The processor 610 can also store and retrieve application data residing in the memory 620. The interconnect 650 is used to transmit programming instructions and/or application data between the processor 610, the user I/O 615, the memory 620, the storage 630, and the network I/O 640. The interconnect 650 can, for example, be one or more busses or the like. The processor 610 can be a single processor, multiple processors, or a single processor having multiple processing cores. In some embodiments, the processor 610 can be a single-threaded processor. In some embodiments, the processor 610 can be a multi-threaded processor.

The user I/O 615 can include a display 616 and/or an input 617, according to some embodiments. It is to be appreciated that the user I/O 615 can be one or more devices connected in communication with the computer device 600 that are physically separate from the computer device 600. For example, the display 616 and input 617 for the desktop computer 602 can be connected in communication but be physically separate from the computer device 600. In some embodiments, the display 616 and input 617 can be physically included with the computer device 600 for the desktop computer 602. In some embodiments, the user I/O 615 can physically be part of the user device 601. For example, the cellular/mobile phone 603, the tablet device 604, and the laptop 605 include the display 616 and input 617 that are part of the computer device 600. The server device 635 generally may not include the user I/O 615. In some embodiments, the server device 635 can be connected to the display 616 and input 617.

The display 616 can include any of a variety of display devices suitable for displaying information to the user. Examples of devices suitable for the display 616 include, but are not limited to, a cathode ray tube (CRT) monitor, a liquid crystal display (LCD) monitor, a light emitting diode (LED) monitor, or the like.

The input 617 can include any of a variety of input devices or means suitable for receiving an input from the user. Examples of devices suitable for the input 617 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 617 can be included for the user devices 601. In some embodiments the input 617 can be integrated with the display 616 such that both input and output are performed by the display 616.

The memory 620 is generally included to be representative of a random access memory such as, but not limited to, Static Random Access Memory (SRAM), Dynamic Random Access Memory (DRAM), or Flash. In some embodiments, the memory 620 can be a volatile memory. In some embodiments, the memory 620 can be a non-volatile memory. In some embodiments, at least a portion of the memory can be virtual memory.

The storage 630 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 630 is a computer readable medium. In some embodiments, the storage 630 can include storage that is external to the computer device 600, such as in a cloud.

The network I/O 625 is configured to transmit data via a network 640. The network 640 may alternatively be referred to as the communications network 640. Examples of the network 640 include, but are not limited to, a local area network (LAN), a wide area network (WAN), the Internet, or the like. In some embodiments, the network I/O 625 can transmit data via the network 640 through a wireless connection using WiFi, Bluetooth, or other similar wireless communication protocols. In some embodiments, the computer device 600 can transmit data via the network 640 through a cellular, 3G, 4G, or other wireless protocol. In some embodiments, the network I/O 625 can transmit data via a wire line, an optical fiber cable, or the like. It is to be appreciated that the network I/O 625 can communicate through the network 640 through suitable combinations of the preceding wired and wireless communication methods.

The server device 635 is generally representative of a computer device 600 that can, for example, respond to requests received via the network 640 to provide, for example, data for rendering a website on the user devices 601. The server 635 can be representative of a data server, an application server, an Internet server, or the like.

Aspects described herein can be embodied as a system, method, or computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are examples only, with the true scope and spirit of the disclosure being indicated by the claims that follow.

What is claimed is:

1. An electronic revenue sharing system, comprising:
a user interface loadable onto a user device, the user device including a display and an input, the user interface configured to enable a shopper to purchase one or more products;
a server communicable with the user device, the server configured to receive a donation request from the user device;
a database electronically accessible to the server, the database including:
profile information for an institution;
donation categories;
donation goals corresponding to the donation categories; and
donation amounts;
wherein, the server is configured to receive the donation request from the user device, retrieve data stored in the database in responding to the donation request, the data including one or more of profile information for the institution, donation categories and donation goals, and/or donation amounts, cause display of the user interface according to the data retrieved, receive a purchase request from the user interface, calculate a corresponding donation amount based on the purchase request, and initiate a distribution of the corresponding donation amount to the institution.

2. The electronic revenue sharing system according to claim 1, wherein the donation request is received from an institution user interface.

3. The electronic revenue sharing system according to claim 1, wherein the donation request is received from a social network user interface.

4. The electronic revenue sharing system according to claim 1, wherein the donation request is received from an electronic revenue sharing system landing user interface and wherein the server causes the electronic revenue sharing system landing user interface to be loaded on the user device.

5. The electronic revenue sharing system according to claim 1, wherein the institution is a not-for-profit organization.

6. The electronic revenue sharing system according to claim 1, the database further comprising:
membership information, the membership information being configured to allow the shopper to designate a default donation institution and/or a default donation category.

7. The electronic revenue sharing system according to claim 1, wherein the donation categories correspond to an intended use of donation funds by the institution.

8. A method for administering an electronic revenue sharing system, comprising:
displaying an electronic revenue sharing system user interface of an institution on a user device;
receiving a donation request from the user device, the donation request indicating selection of a particular donation category for the institution;
receiving a purchase request from the user device, the purchase request indicating one or more items a shopper has selected for purchase; and
calculating a donation amount based on the purchase request.

9. The method according to claim 8, wherein the calculating includes:
determining an amount of the purchase request; and
calculating a percentage of the purchase request to be shared with the institution.

10. The method according to claim 8, further comprising:
initiating a distribution of the donation amount to the institution, wherein the distribution is directed to the particular donation category.

11. The method according to claim 8, wherein the institution is selected based on a request received from a social network user interface.

12. The method according to claim 8, wherein the institution is selected based on a request received from a user interface of the institution.

13. The method according to claim 8, wherein the institution is selected based on a request received from an electronic revenue sharing system landing user interface.

14. A system, comprising:
a server communicable with a network, the server executing instructions for a user interface and displaying the user interface on a display of a user device for donating to an institution, the user interface comprising:
one or more donation category panels, each of the one or more donation category panels including:
a category icon;
a category description;
a tracking bar;
an accumulation number;
a donation goal; and
a connector,
wherein the connector is configured to direct a shopper to a retail website such that the shopper can purchase one or more items and cause a portion of the shopper's purchase amount to be donated to the institution.

15. The system according to claim 14, wherein the one or more donation category panels correspond to an intended use of donation funds by the institution.

16. The system according to claim 14, wherein the tracking bar is configured to display progress toward the donation goal for the corresponding donation category panel.

17. The system according to claim 14, wherein the portion of the shopper's purchase amount to be donated to the institution is a percentage of a total amount of a purchase request by the shopper.

18. The system according to claim 14, wherein the portion of the shopper's purchase amount to be donated to the institution is directed a selected donation category corresponding to one of the one or more donation category panels.
